(19) United States
(12) Patent Application Publication
(10) Pub. No.: US 2023/0219736 A1
(43) Pub. Date: Jul. 13, 2023

(54) Condiment Dispenser 1

(71) Applicant: Leamond Sloan, Cahokia Heights, IL (US)

(72) Inventor: Leamond Sloan, Cahokia Heights, IL (US)

(21) Appl. No.: 17/930,003

(22) Filed: Sep. 6, 2022

Related U.S. Application Data
(60) Provisional application No. 63/297,669, filed on Jan. 7, 2022.

(51) Int. Cl. B65D 83/00; A47J 47/01

(52) U.S. Cl. CPC B65D 83/0094; A47J 47/01

(57) ABSTRACT

The objective of this invention (CD1) is to reduce the spread of viruses and germs that causes illness, disease, and death. To help eliminate the coronavirus, its variants and any future harmful contaminates that contributes to health issues. The CD1 reduces time for usage and increases convenience. Condiments cannot be lost easily.

The CD1 can be made of metal, plastic and/or other materials that are safe, sturdy, easily assembled and cleaned.

The CD1 was created to eliminate the spreading of germs, dirt, and viruses. The present invention (idea) relates to a system that dispenses condiments by using foot controls. Hands are not needed as commonly practiced for the dispensing of condiments.

The product is comprised of but not limited to the following components:

The CD1 will consist of at least a tank (housing), press bars, counter, press bar mounts, retainer thumb, cables, foot controls, shelf, safety retainer, stand, counter-press bars, window (view area to look at available condiments), glass, plexiglass, springs, restrictors, regulators. The CD1 is a basic functioning model with modification possibilities and some features/possibly not shown.

The tank can be designed to accommodate different sizes of squeezable bottles. The tank will/may contain all the components for operation on future models. The CD1 operates by having a squeezable bottle placed in the orifice (the hole where the top of the product is placed, bottom side up on many products) inside the tank. The hole is located on the bottom of the tank. This allows the bottle to be squeezed by the press bar to force the condiment out of the bottle through the hole in the top (cap that seals the bottle). The foot presses the pedal connected to the cable that applies pressure to operate the mechanism (press bar) in the tank that squeezes the plastic bottle that contains the condiment, and a portion of the condiment is released (squeezed out) through hole in cap.

The tank can accommodate one or multiple bottled products by design. The tank can be designed to allow a space for extra storage for additional products. The CD1 must be designed for at least one product.

The CD1 should be engineered and manufactured by industry professionals. It does not take a lot of training to fill with condiments, replace used condiments, clean, or operate the CD1. It can be maintained and operated by common sense means.

The CD1 was created to eliminate the spreading of germs, dirt, and viruses in a time of great need to help stop the coronavirus pandemic. It eliminates the need to pick up the desired condiment, use it, and place it down for the next user. Or picking up packaged condiments from a bowl, basket, or holding container. This process can have devastating effects on following users.

### BRIEF DESCRIPTION OF THE DRAWINGS

FIG. 1 is a front view of the CD1 that shows the available condiments through a window.

FIG. 2 is a top view of the CD1 that shows the components and the bottom of the housing.

FIG. 3 is a right-side view of the CD1 that shows the major external components.

FIG. 4 is a front pictorial view.

FIG. 5 is an overhead pictorial front view.

FIG. 6 is an overhead pictorial right side view.

### DETAILED DESCRIPTION OF THE DRAWINGS

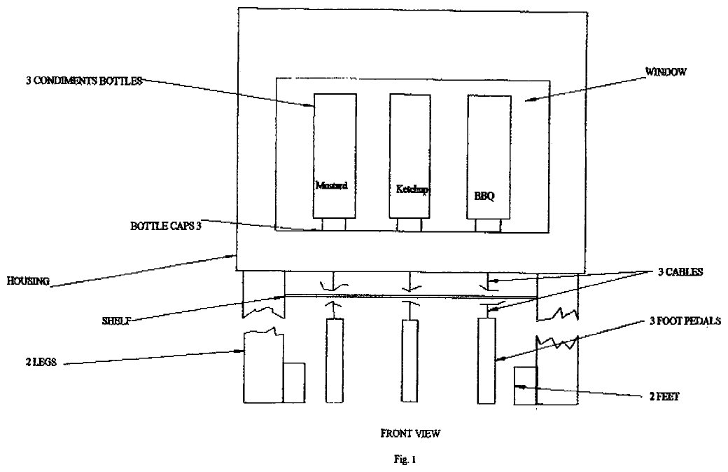

### Description of FIG. 1

LEGS: there are 2 legs that support the CD1, one on each side.

SHELF: the purpose of the shelf is to prevent accidental spills on clothing and surroundings.

HOUSING: the housing encapsulates all the operating components of the CD1.

BOTTLE CAPS: the bottle caps are placed in the holes located on the bottom (floor) of the housing.

CONDIMENT BOTTLES: there are 3 condiment bottles in the model for dispensing.

WINDOW: there is one window for viewing the contents (the condiments).

CABLES: there are 3 cables, one attached to each of the foot pedals and press bars.

FOOT PEDALS: there are three foot pedals. The purpose for the foot pedal is to dispense the desired condiment when pressed.

FEET: there are two feet attached to the legs for balance and support, one on each side.

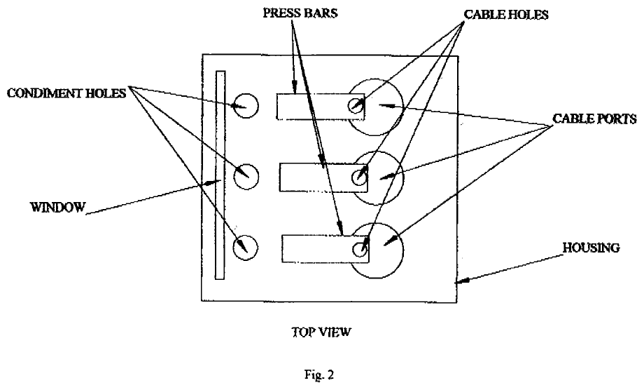

### Description of FIG. 2

WINDOW: the window is the transparent piece of plastic or glass that allows the contents to be seen. A window is not needed, labels can be placed on windowless housing to identify internal contents to be dispensed.

CONDIMENTS HOLES: the three condiments holes in the bottom of the housing permit the condiments to be loaded with the tops of the condiments protruding downward through the holes. These are the proper positions for the tops of the condiments to operate by squeezing out the condiments.

PRESS BARS: the press bars are made of a hard material (metal in this case). The press bars are the mechanism that presses the condiment bottles when the foot pedals are pressed. The press bars are controlled by attached wires on its rear.

CABLE HOLES: the cable holes are located at the rear of the press bars and are for the attached wires that controls the pivoting motion of the press bars.

CABLE PORTS: the cable ports are holes in the bottom of the housing that allow freedom of moment of the wires (cables which are attached to the foot pedals and press bars).

HOUSING: the housing is the total enclosure of the CD1 components. It consists of a lid, four sides (the front side contains a window), and a bottom.

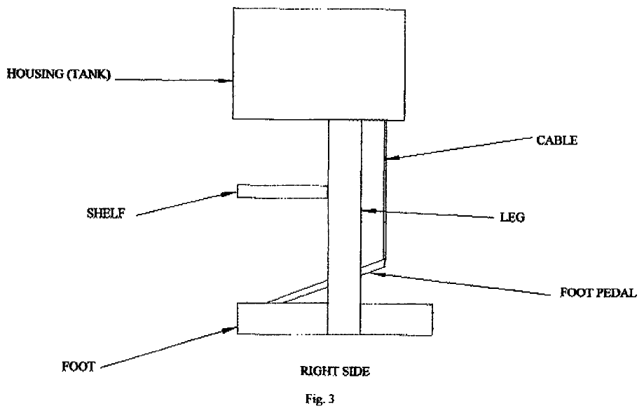

### Description of FIG. 3

FOOT: the foot provides stability for the CD1 and there is one on each side attached to the bottom of the legs.

SHELF: the purpose of the shelf is to prevent accidental spills on clothing and surroundings.

HOUSING (TANK): the housing encapsulates all the operating components of the CD1.

CABLE: there are 3 cables, and they connect the press bars located in the housing and to the foot pedals. Their purpose is to pull on the press bar that squeezes the condiment bottles.

LEG: there are 2 legs, one on each side that supports the CD1. They are connected to the housing and feet.

FOOT PEDAL: the foot pedal operates the press bar in the housing via the cable. This model has three foot pedals. Future models may contain more or fewer condiments requiring more or fewer foot pedals.

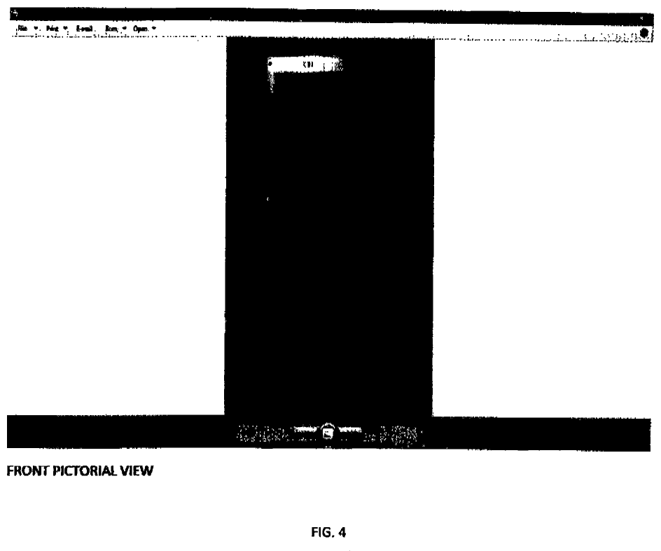

### Description of FIG. 4

FRONT PICTORIAL VIEW

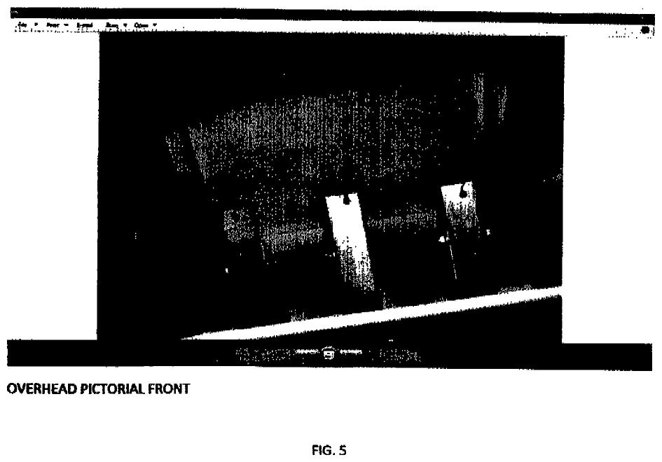

### Description of FIG. 5

OVERHEAD PICTORIAL FRONT

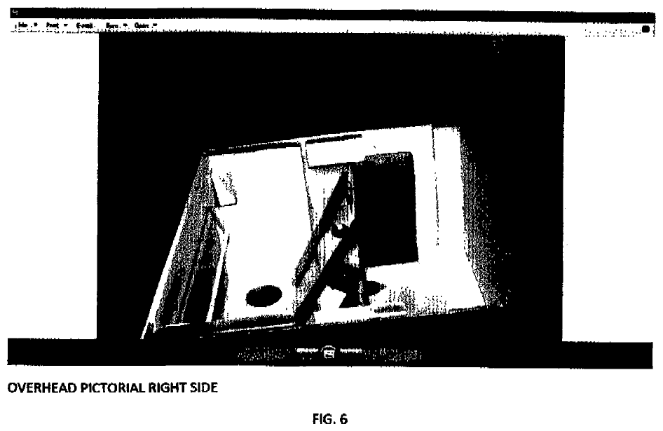

### Description of FIG. 6

OVERHEAD PICTORIAL RIGHT SIDE

### How the CD1 is Made

The Condiment Dispenser 1 (PROTOTYPE) is made by hand from the following materials. Future models of the CD1 can be made from molds by industrial standards.

The CD1 (PROTOTYPE) is made of a selection of materials. It consists of paint, cables, cables fasteners, plastic, wood, plexiglass, steel, pvc piping, screws, washers, nuts, and bolts. Future units/models can be made of fewer materials and mostly plastic/metal.

NOTE: NO NEW MATTER.

What is claimed:

1. The CD1 works by pressing the foot pedal that is connected to a cable or some other kind of connector to operate the squeezing mechanism (press bar) for the plastic bottle located in the tank (housing). The pressure applied by the foot causes the selected condiment to be dispensed.

2. The CD1 does not operate by conventional practices. The CD1 will not spread germs the way condiments are used currently by touching the condiment container.

3. The CD1 condiments are restricted to the public by an enclosure (the housing) to ensure no direct contact is made with the products.

4. The CD1 is easy to operate and safe.

5. The CD1 has a small profile and can be placed in many areas.

6. The CD1 does not require the use of hands to operate, which allows greater freedom of hands.

7. The CD1 can be designed with wheels for easy movement and transporting.

8. A window is not needed in the housing; labels can be placed on windowless housing models to identify internal contents to be dispensed.

9. The CD1 housing helps to protect against airborne germs and viruses from breathing, sneezing, and coughing.

10. The CD1 is easily detected.
